(19) United States
(12) Patent Application Publication
(10) Pub. No.: US 2012/0034953 A1
(43) Pub. Date: Feb. 9, 2012

(54) WIRELESS HANDSET HAVING COMBINED MULTIPLE DISPLAYS

(75) Inventor: Vishnuvardhan VC CHOWDARY, Bangalore (IN)

(73) Assignee: Kyocera Corporation, Kyoto (JP)

(21) Appl. No.: 12/852,304

(22) Filed: Aug. 6, 2010

(51) Int. Cl. H04B 1/38; G09G 5/00

(52) U.S. Cl. 455/566; 345/1.3

(57) ABSTRACT

A wireless handset having combined multiple displays is described. The wireless handset comprises a base component and a second component movably coupled to the base component. A first display is located on the base component and a second display is located on the second component. When the second component is deployed, the first display is located adjacent to the second display. In one embodiment, the first display and the second display are configured to show two parts of the same content. In another embodiment, the first display and the second display are configured to show different content. In yet another embodiment, a user interface is configured to toggle between a first mode, in which the first display and the second display show different parts of the same content, and a second mode, in which the first display and the second display show different content.

### FIELD

The present invention relates to a wireless handset having multiple displays. More particularly, the invention relates to a wireless handset with multiple displays that which form a combined display when a second component is deployed relative to a base component.

### BACKGROUND

Wireless handsets typically require displays having a small footprint to promote the portability of the device. However, the small display size limits the utility of the handset. While many handsets now provide access to the Internet and allow viewing of images and videos, the small screen size may inhibit use of these features.

A wireless handset having multiple displays that are simultaneously viewable would allow content requiring a large display to be viewed on a compact device. Wireless handsets having multiple displays are typically configured such that the displays are not simultaneously viewable. For example, a mobile phone having a clamshell configuration may have a first display visible only when the phone is closed and a second display visible only when the phone is opened. Existing wireless handsets having simultaneously viewable multiple displays have multiple display panels coupled to a base component. Thus, it is thus desirable to have wireless handset comprising a display on a base component and a display on a second component coupled to the base component that would be more economical and compact than a wireless handset with multiple display panels coupled to a base component.

### SUMMARY

A wireless handset having combined multiple displays is described. The wireless handset comprises a base component and a sliding panel slidably coupled to the base component. A first display is located on the base component and a second display is located on the sliding panel. When the sliding panel is extended, the first display is located adjacent to the second display.

In one embodiment, the first display and the second display are configured to show two parts of the same content. In another embodiment, the first display and the second display are configured to show different content. In yet another embodiment, a user interface is configured to toggle between a first mode, in which the first display and the second display show different parts of the same content, and a second mode, in which the first display and the second display show different content.

In another embodiment, the wireless handset comprises a base component and a second component movably coupled to the base component and a means for positioning the first display adjacent to the second display. The first display is located on the base component and a second display is located on the second component.

A method for simultaneous viewing of multiple displays on a wireless handset is also described. The method comprises moving a sliding panel having a second display relative to a base component having a first display such that the first display is located adjacent to the second display. In a first mode, two parts of the same content are presented on the first display and the second display. In a second mode, different content on the first display and the second display is presented.

### DRAWINGS

The present invention will be more fully understood by reference to the following drawings which are for illustrative, not limiting, purposes.

FIG. 1 shows a side view of an illustrative wireless handset having a keypad interface.

FIGS. 2A-2B show front views of an illustrative wireless handset having keypad interfaces.

FIG. 3 shows a side view of an illustrative wireless handset having a touch screen interface.

FIG. 4 shows a front view of an illustrative wireless handset having a touch screen interface.

FIG. 5 shows an illustrative communication system.

FIG. 6A shows an illustrative wireless handset showing two parts of the same content on a first display and a second display.

FIG. 6B shows an illustrative wireless handset showing different content on the first display and the second display.

FIG. 6C shows an illustrative wireless handset showing text on the first display and the second display.

FIGS. 7A-7C show illustrative wireless handsets in a second display mode associated with a second orientation of the wireless handset.

FIG. 8 shows an illustrative flowchart of the method for changing the orientation of the display in response to a change in the orientation of the handset.

### DETAILED DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the wireless handset, systems, and methods described hereinafter may vary as to configuration and as to details.

A wireless handset having a combined internal and external display is described. A first display is located on a base component of the wireless handset. A second component having a second display is coupled to the base component. When the second component is deployed, the first display is located adjacent to second display, such that both displays are simultaneously visible.

In an illustrative embodiment, the second component is slidably coupled to the base component, in which case the second component is referred to as a sliding panel. It will be recognized that other coupling means may be used to movably couple the second component to the base component. For example, the second component may be coupled to the base component with a hinge. The hinge may be located at the top of the device, such that the second panel is opened by flipping it upward. Alternatively, the hinge may be located at the left or right side of the device so that the second panel is opened by flipping it to the left or to the right, respectively, relative to the base component. In an embodiment having a hinge coupling, the second display is located on the interior face of the second panel, such that it is visible when the second panel is flipped to the open position. The second panel may additionally have a third display visible when the second panel is closed.

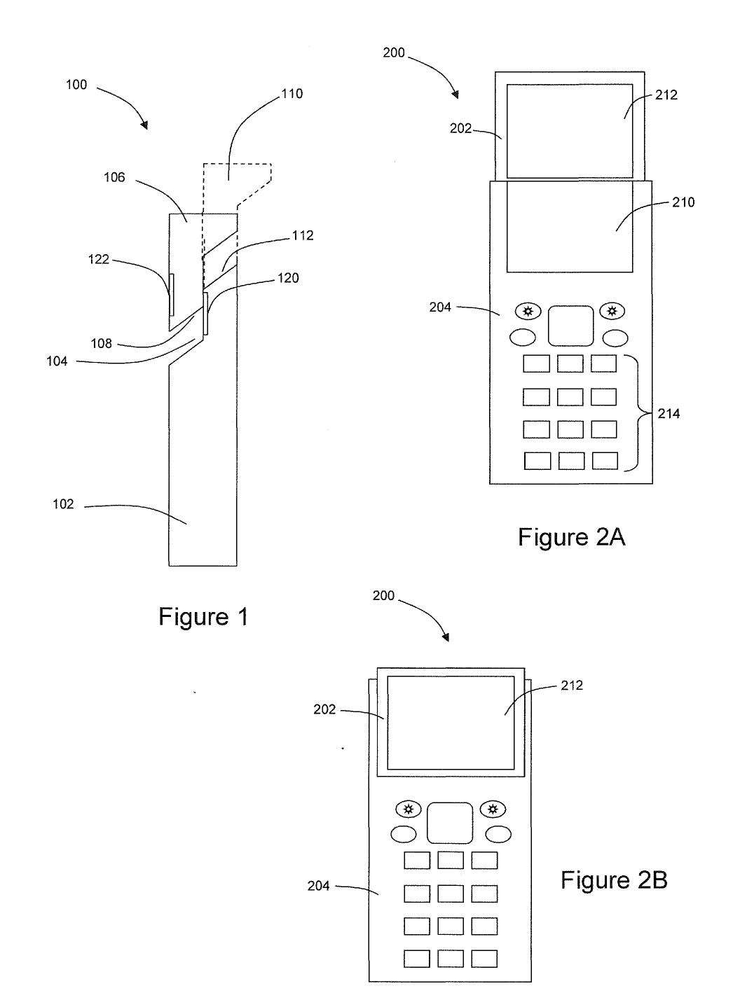

Referring to FIG. 1, a side view of an illustrative wireless handset 100 having a keypad interface and a base component slidably coupled to a sliding panel is shown. Base component 102 has recessed area 104 to receive sliding panel 106. The sliding panel 106 is extended until the sliding panel is fully deployed, as illustrated by the sliding panel shown in a dotted outline at 110.

In the illustrative embodiment, a first display 120 is disposed on the base component 102. A second display 122 is housed by the sliding panel 106.

The slidable coupling may be a track system in which rails coupled to the posterior face of the sliding panel slide along grooves in the anterior face of the base component. In an embodiment in which the lower edge 108 of sliding panel 106 couples to upper edge 112 of base component 102, as shown at 110, lower edge 108 may be coupled to upper edge 112 by a spring-loaded mechanism with posts that extend into the sliding panel when the sliding panel is fully deployed. It will be recognized that other fastening means may be used to secure the sliding panel to the base panel when the sliding panel is fully deployed.

In FIG. 1, the sliding panel is shown sliding vertically relative to the base component. In an alternative embodiment, the sliding panel slides horizontally relative to the base component. The sliding coupling may be configured to allow the sliding panel to slide to the left of the base component or to allow the sliding panel to slide to the right of the base component. Alternatively, the sliding coupling may be configured to allow the sliding panel to slide to the right and to the left of the base component. In some embodiments, the coupling between the sliding component and the base component comprises both a sliding mechanism and a swivel mechanism. The swivel mechanism allows the sliding component to swivel clockwise and counterclockwise relative to the base component.

Referring to FIG. 2A, a front view of an illustrative wireless handset 200 with sliding panel 202 fully deployed is shown. In FIG. 2B, a top view of an illustrative wireless handset 250 with sliding panel 252 retracted is shown. Sliding panel 202 is slidably coupled to base component 204. A first display 210 is located on the base component 204. A second display 212 is located on the sliding panel. When the sliding panel is fully deployed, as shown in FIG. 2A, the first display 210 is adjacent to the second display 212. In this manner, a large display comprised of the first display 210 and the second display 212 is formed.

The first display 210 and the second display 212 may share the same display area and show two parts of the same content. Additionally, the first display 210 and the second display 212 may be associated with different display areas so that the first display and configured to show two parts of the same content. Furthermore, a user interface is configured to toggle between a first mode, in which the first display and the second display show different parts of the same content, and a second mode, in which the first display and the second display show different content.

The illustrative wireless handset 200 is shown with a user interface comprising a keypad 214. The keypad user interface may be, for example, an alphanumeric or QWERTY keypad, and may comprise additional function keys. The user interface may further comprise a touch screen display. In some embodiments, first display 210, second display 212, or both of the first and second displays are touch screen interfaces.

Referring to FIG. 2B, illustrative wireless handset 200 has base component 204 and sliding component 202. Sliding panel 202 is shown partially retracted. In some embodiments, the top of the sliding panel will be flush with the top of the base component when the sliding panel is fully retracted. The sliding panel may be locked into place when fully retracted. The first display is behind sliding panel 202 and is no longer visible to the user of the wireless handset. When sliding panel 202 is fully retracted, the first display (not visible) is disabled and second display 212 remains enabled as the main display for the handset.

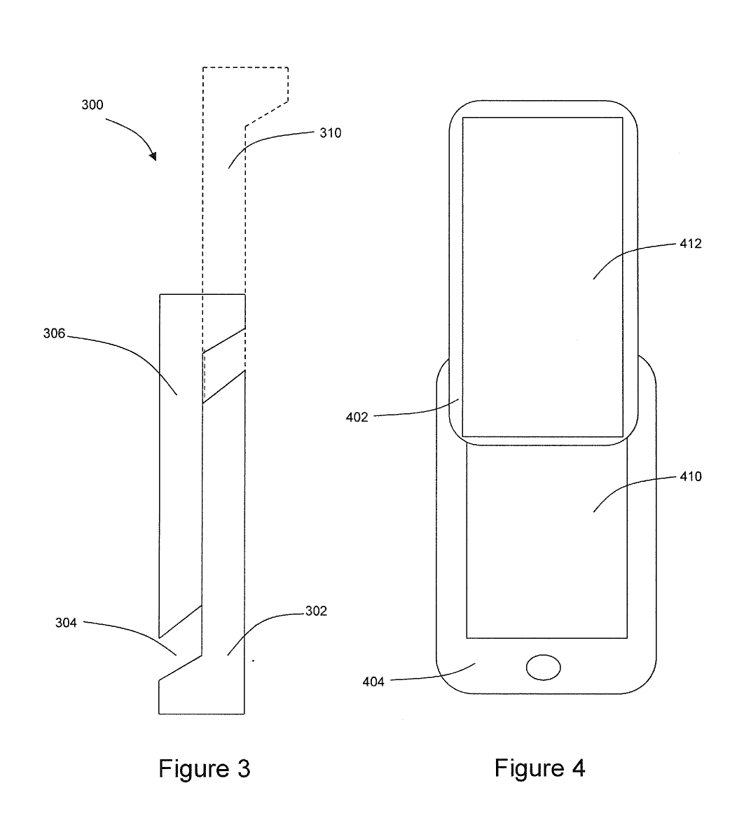

Referring to FIG. 3, a side view of an illustrative wireless handset 300 having a touch screen interface is shown. Base component 302 has recessed area 304 to receive sliding panel 306. The sliding panel 306 is extended until the sliding panel is fully deployed, as illustrated by the sliding panel shown in a dotted outline at 310.

Referring to FIG. 4, a front view of an illustrative wireless handset 400 having a touch screen interface is shown. A first display 410 is located on the base component 404. A second display 412 is located on the sliding panel 402. Sliding panel 402 is shown partially deployed. When the sliding panel is fully deployed, as indicated at 310, the first display is adjacent to the second display. In this manner, a large display comprised of the first display and the second display is formed. The first display 410 and the second display 412 may have the same display area. Alternatively, the first display and the second display may have different display areas. A virtual keypad may be displayed on the first display 410 when the sliding panel is fully deployed. Illustrative wireless handset 400 has a user interface comprising a touch screen display. First display 410, second display 412, or both of the first and second displays may be touch screen interfaces.

In some embodiments, the top of sliding panel 402 will be flush with the top of base component 404 when the sliding panel is fully retracted. The sliding panel may be locked into place when fully retracted. When the sliding panel is fully retracted, first display 410 is located behind sliding panel 412 and is no longer visible to the user of the wireless handset. The first display is disabled and the second display remains enabled as the main display for the handset.

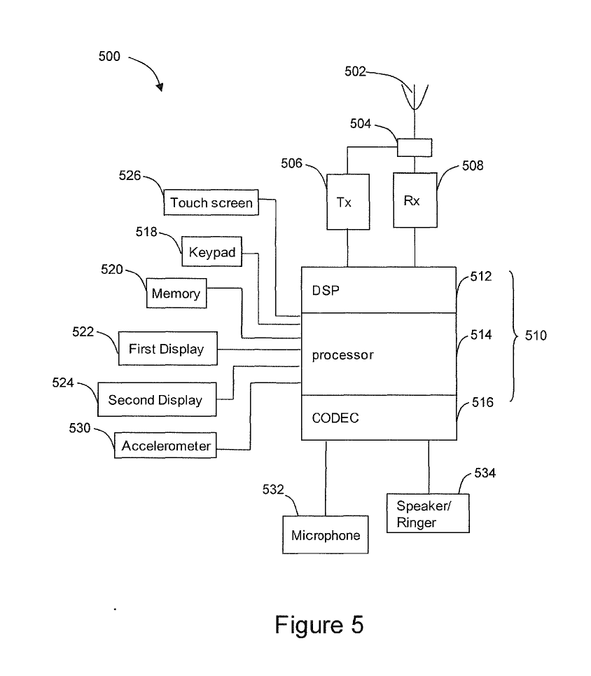

Referring to FIG. 5, there is shown a plurality of components associated with an illustrative wireless handset. The illustrative wireless handset 500 comprises a first antenna element 502 that is operatively coupled to a duplexer 504, which is operatively coupled to a transmitter module 506, and a receiver module 508.

An illustrative control module 510 comprises a digital signal processor (DSP) 512, a processor 514, and a CODEC 516 that are communicatively coupled to the transmitter 506 and receiver 508. It shall be appreciated by those of ordinary skill in the art that the transmitter module and receiver module are typically paired and may be embodied as a transceiver. The DSP 512 may be configured to perform a variety of operations such as controlling the antenna 502, the transmitter module 506, and the receiver module 508.

The processor 514 is operatively coupled to a keypad 518, memory 520, first display 522 and second display 524. In some embodiments, the processor is operatively coupled to a touch screen interface 526. The processor may also be operatively coupled to an accelerometer 530. Additionally the processor 514 is operatively coupled to a CODEC module 516 that performs the encoding and decoding operations and is communicatively coupled to microphone 532 and a speaker or ringer 534. The CODEC module 516 is also communicatively coupled to the first display 522 and the second display 524 and provides the encoding and decoding operations for video.

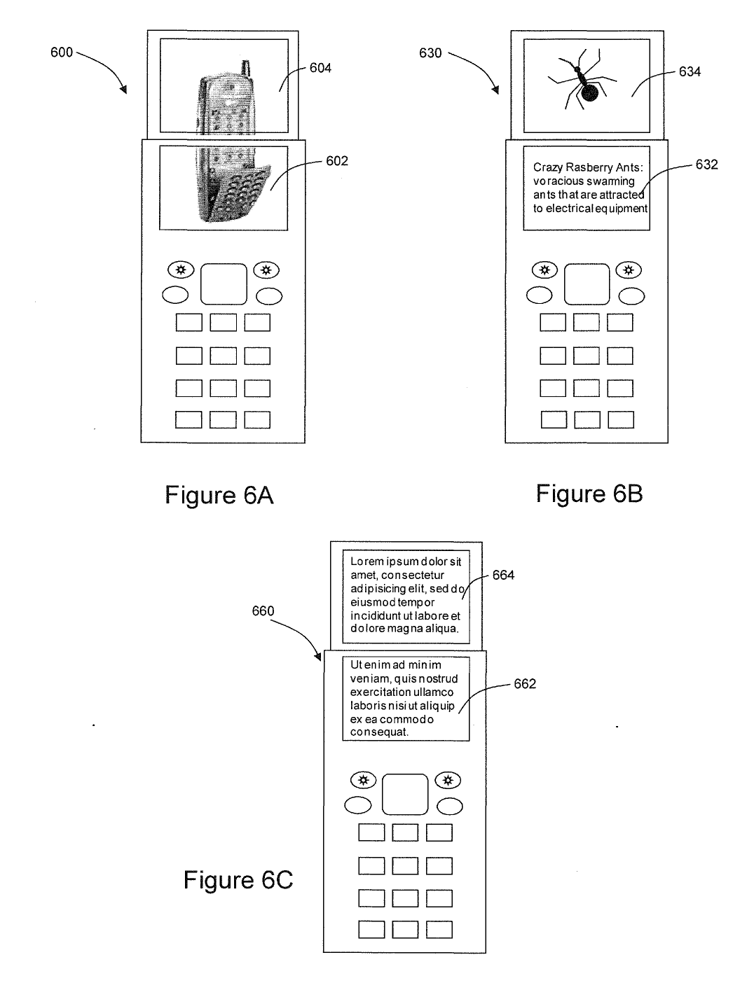

Referring to FIG. 6A, an illustrative wireless handset 600 showing two parts of the same content on a first display and a second display is shown. Content shown on the first display and the second display includes images, text, and video. In FIG. 6A, a single image is shown on first display 602 and second display 604. The lower half of the image appears on the first display and the top half of the image appears on the second display.

Referring to FIG. 6B, an illustrative wireless handset 630 showing different content on a first display and a second display is shown. An image is shown on second display 634 and explanatory text for the image is shown on first display 632. The content shown on the first display may or may not relate to the content shown on the second display.

Referring to FIG. 6C, an illustrative handset 660 showing text on a first display and a second display is shown. A first portion of the text is shown on second display 664 and a second portion of the text, continuing from the first portion of the text, is shown on first display 662.

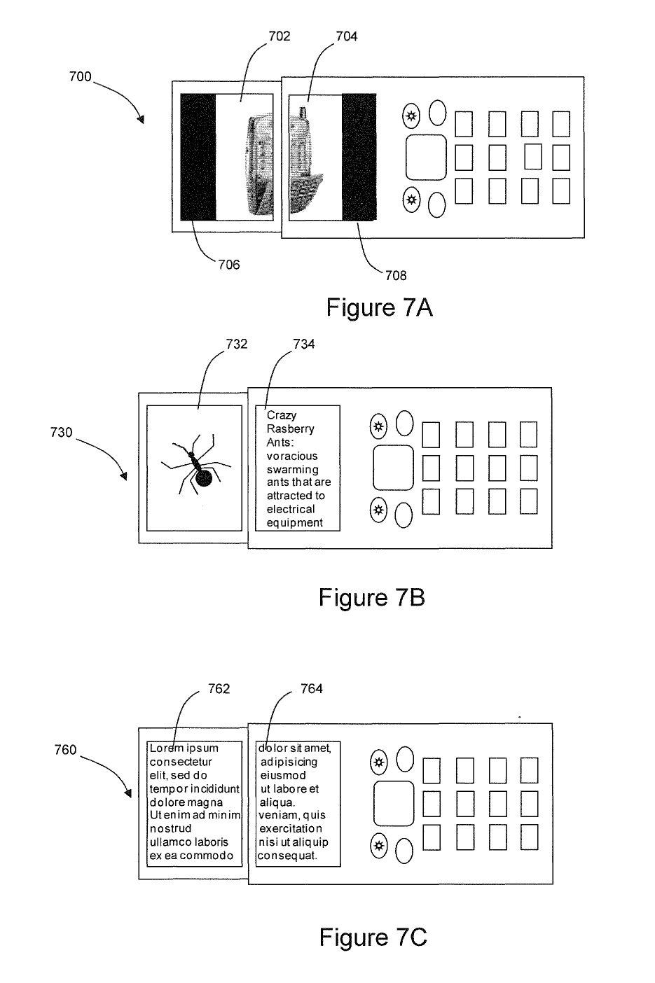

Referring to FIG. 7, illustrative wireless handsets in a second display mode associated with a second orientation of the wireless handset are shown. In FIG. 6A, illustrative wireless handset 600 is shown in a first orientation in which the first display 602 and the second display 604 are aligned vertically. In FIG. 7A, the wireless handset 700 has been rotated to a second orientation in which the first display 702 and the second display 704 are aligned horizontally. In FIG. 6A, the content is shown on the first display and the second display in a first mode, which may be referred to as “portrait” mode. In FIG. 7A, the content is shown in a second mode, which may be referred to as “landscape” mode.

The orientation of the wireless handset is detected by an accelerometer 530. The accelerometer senses non-gravitational acceleration imparted to the device in one or more axes. The change in the position of the wireless handset may be derived from the acceleration signal produced by the accelerometer. The accelerometer comprises a sensing element that is used to determine the acceleration to which the wireless handset is exposed. The sensing element may utilize, by way of example, capacitive, piezoelectric, piezoresistive, or MEMS (Micro-Electro Mechanical System) technology. It will be recognized that other technologies may be utilized to provide data regarding changes in the position of the handset to the processor.

When the phone is rotated from a first orientation to a second orientation, the accelerometer 530 senses the change in orientation. The processor 514 receives the accelerometer signal and determines whether the change in orientation requires a change in display mode. For example, if the rotation of the handset results in an orientation in which the first display and the second display, which were previously aligned vertically, are subsequently aligned horizontally, the processor may determine that a change from a first display mode to a second display mode is required.

The processor 514 may adjust the size of the displayed content to fit on the combined display in the second mode. The processor may preserve the aspect ratio of the image when the image size is increased or decreased. In one embodiment, the processor may apply letterbox formatting to the content, as shown in FIG. 7A. Letterbox formatting involves resizing the content to fit a different format, preserving the aspect ratio of the content, and placing mattes 706 and 708, which may be black bars, in the space left unoccupied on the display surrounding the downsized content.

In FIG. 6B, illustrative wireless handset 630 is shown in a first orientation in which the first display 632 and the second display 634 are aligned vertically. In FIG. 7B, the wireless handset 700 has been rotated to a second orientation in which the first display 732 and the second display 734 are aligned horizontally. In FIG. 6B, different content is shown on the first display and the second display. In FIG. 7B, the content of first display 632 is shown rotated on first display 732 and the content shown on second display 634 is shown rotated on second display 734.

In FIG. 6C, illustrative wireless handset 660 is shown in a first orientation in which the first display 632 and the second display 634 are aligned vertically. In FIG. 7C, the wireless handset 760 has been rotated to a second orientation in which the first display 762 and the second display 764 are aligned horizontally. In FIG. 6C, text is shown on the first display and the second display. In FIG. 7C, the text is shown wrapping horizontally across first display 732 and second display 734. Documents, websites, and other content having text may be displayed with text wrapping adjusted according to the orientation of the handset.

In some embodiments, the display mode will be prevented from changing when the orientation of the wireless handset changes. For example, when the first display and the second display show the same content, as illustrated in FIG. 6A, the processor 514 may be configured to prevent a change to a second display mode. In accordance with the example, when the handset is rotated as shown in FIG. 7A, the display remains unchanged from the display mode shown in FIG. 6A. The processor may be configured to allow a change to the second display mode shown in FIG. 7B when the first display and the second display show different content as shown in FIG. 6B. The processor may also be configured to allow a change to the second display mode shown in FIG. 7C when the first display and the second display show text as shown in FIG. 6C.

In another illustrative embodiment, the user may lock the display mode. For example, keypad 214 may comprise a key allowing the user to access a lock function. Alternatively, a specialized button or other physical interface device may be provided on the handset to allow the user to lock the display mode. In a wireless handset having a touch screen interface, the touch screen may display an icon or menu option corresponding to a lock function. The lock function allows the user to lock and unlock the display. When the display is locked, the processor 514 is configured to prevent a change in the display mode when the user rotates or otherwise changes the orientation of the handset.

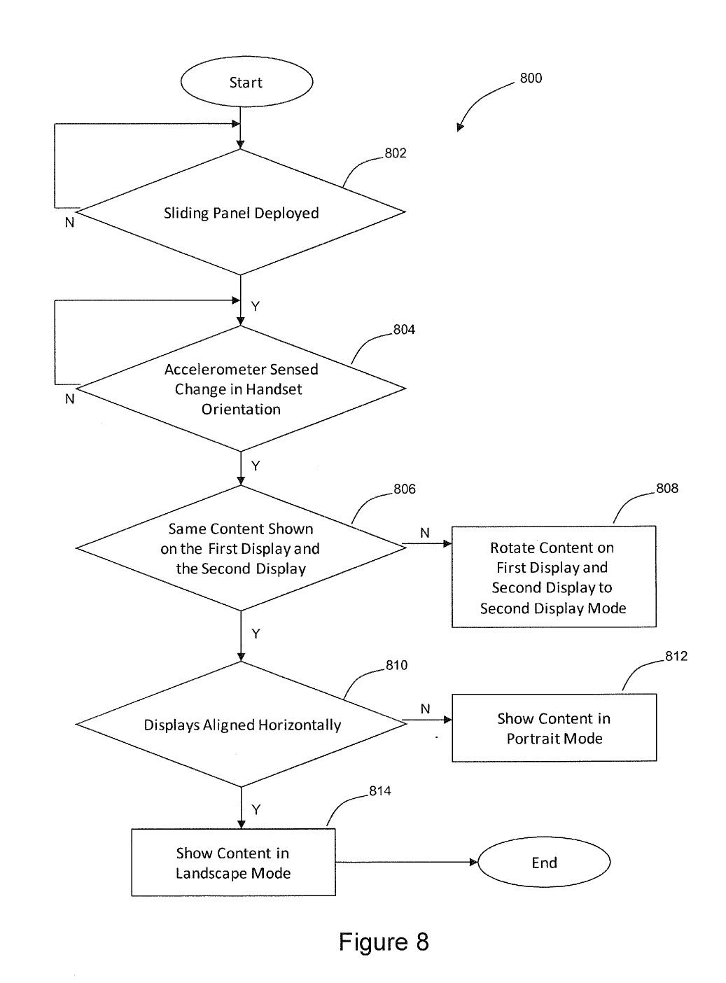

Referring to FIG. 8, an illustrative flowchart of the method for changing the orientation of the display in response to a change in the orientation of the handset is shown. The method begins at decision diamond 802, in which processor 514 determines whether sliding panel 202 of the wireless handset is deployed. If the sliding panel is deployed, as shown in FIG. 2A, the method proceeds to decision diamond 804, in which the processor interprets input received from accelerometer 530 to determine whether a change in the orientation of the wireless handset has occurred. If a change in orientation has occurred, such as the change in orientation that occurs between FIG. 6A and FIG. 7A, the method proceeds to decision diamond 806, in which the processor determines whether the same content is shown on the first display and the second display, as illustrated in FIG. 6A. If the same content is not shown on the first display and the second display, then the first display and the second display show different content, as illustrated in FIG. 6B, and the method proceeds to block 808. At block 808, the content on the first display and the content on the second display is rotated to a second display mode, as illustrated in FIG. 7B. If the same content is shown on the first display and the second display, the method proceeds to decision diamond 810, in which the processor determines whether, in the new wireless handset orientation, the displays are aligned horizontally, as illustrated in FIG. 7A. If the displays are aligned horizontally, the method proceeds to block 812, in which the processor displays the content in landscape mode. If the displays are aligned vertically, as illustrated in FIG. 6A, the method proceeds to block 814, in which the processor displays the content in portrait mode.

A wireless handset having multiple displays which may be positioned adjacent to each other to form a combined display has been described above. A first display is located on a base component and a second display is located on a second component movably coupled to the base component. When the second component is retracted, only the second display is visible. The first display and the second display are simultaneously visible and form a combined display when the second component is deployed.

It is to be understood that the detailed description of illustrative embodiments are provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A wireless handset, comprising:
a base component;
a sliding panel slidably coupled to the base component;
a first display on the base component;
a second display on the sliding panel;
wherein the first display is adjacent to the second display when the sliding panel is extended.

2. The wireless handset of claim 1, wherein the first display and the second display are configured to show two parts of the same content.

3. The wireless handset of claim 1, wherein the first display and the second display are configured to show different content.

4. The wireless handset of claim 1, further comprising a user interface configured to toggle between a first mode, in which the first display and the second display show different parts of the same content and a second mode, in which the first display and the second display show different content.

5. The wireless handset of claim 1, wherein at least one of the first display and the second display comprises a touch screen.

6. The wireless handset of claim 1, further comprising a user interface, wherein the user interface is a keypad.

7. The wireless handset of claim 1, further comprising an accelerometer, wherein content shown on the first display and the second display is changed from a first mode to a second mode according to a change in orientation of the wireless handset as sensed by the accelerometer.

8. The wireless handset of claim 7, wherein the orientation of content shown on the display is locked when the first display and the second display show the same content.

9. A wireless handset, comprising:
a base component;
a second component movably coupled to the base component;
a first display on the base component;
a second display on the second component;
a means for positioning the first display adjacent to the second display.

10. The wireless handset of claim 9, wherein the first display and the second display are configured to show two parts of the same content.

11. The wireless handset of claim 9, wherein the first display and the second display are configured to show different content.

12. The wireless handset of claim 9, further comprising a means for toggling between a first mode in which, the first display and the second display show different parts of the same content and a second mode in which, the first display and the second display show different content.

13. The wireless handset of claim 9, wherein at least one of the first display and the second display comprises a touch screen.

14. The wireless handset of claim 9, further comprising a user interface, wherein the user interface is a keypad.

15. The wireless handset of claim 9, further comprising an accelerometer, wherein content shown on the first display and the second display is changed from a first mode to a second mode according to a change in orientation of the wireless handset as sensed by the accelerometer.

16. The wireless handset of claim 15, wherein the orientation of content shown on the display is locked when the first display and the second display show the same content.

17. A method for simultaneous viewing of multiple displays on a wireless handset, the method comprising:
moving a sliding panel having a second display relative to a base component having a first display such that the first display is located adjacent to the second display;
presenting two parts of the same content on the first display and the second display in a first mode; and
presenting different content on the first display and the second display in a second mode.

18. The method of claim 17, further comprising:
sensing a change in the orientation of the wireless handset from a first position to a second position with an accelerometer; and
changing the orientation of the content shown on the first display and the second display from a first mode to a second mode when the change in the orientation of the wireless handset is sensed by the accelerometer.

19. The method of claim 18, further comprising:
locking the orientation of the content shown on the display when the first display and the second display show the same content.
